(19) United States
(12) Patent Application Publication
(10) Pub. No.: US 2022/0318677 A1
(43) Pub. Date: Oct. 6, 2022

(54) SELF-PROGRAMMING MACHINE AND METHOD

(71) Applicant: INGENIATION PTY LTD, Subiaco, Western Australia (AU)

(72) Inventor: Wolfgang BARTELT, Subiaco (AU)

(73) Assignee: INGENIATION PTY LTD, Subiaco, Western Australia (AU)

(21) Appl. No.: 17/640,765

(22) PCT Filed: Sep. 3, 2020
(86) PCT No.: PCT/AU2020/000101

§ 371 Date: Mar. 4, 2022

(30) Foreign Application Priority Data
Sep. 6, 2019 (AU) 2019903307

(51) Int. Cl. G06N 20/00; G06F 8/35

(52) U.S. Cl. CPC G06N 20/00; G06F 8/35

(57) ABSTRACT

A method for constructing a self-programming machine comprises determining a target attractor of a complex dynamical system, the attractor comprising event processing nodes and event flows propagating between the nodes, and constructing a fragmented process model of the attractor having event processing nodes corresponding to nodes of the attractor. Logical processing units are constructed, each comprising a communications interface and an input/output for receiving/sending information from/to an external environment or process. Instances of the process model are created and associated with the processing units with interaction regions interposed between the instances. The processing units are configured to (i) form bindings between nodes of the instances via the interaction regions in accordance with attractor event flows, (ii) generate, send and receive event signals via the communications interfaces in accordance with the bindings (iii) process event signals received via the communications interfaces and information from their inputs to determine output information.

### FIELD

The present invention relates to artificial general intelligence and, more particularly, to a self-programming machine and related method.

### BACKGROUND

Artificial general intelligence (AGI) is machine intelligence that has the capacity to understand or learn intellectual tasks similar to those that human beings can perform. AGI is sometimes referred to as strong artificial intelligence (AI) and, in one aspect, constitutes the representation of generalised human cognitive abilities in computer systems that, when faced with unfamiliar tasks, are able to determine solutions. AGI systems require advanced knowledge and cognitive abilities such that their performance of intellectual tasks is comparable to, or exceeds, that of humans.

An autopoietic machine may be defined as a self-creating machine organized as a network of processes that produce (via transformation and destruction) components which through their interactions and transformations continuously regenerate and realize the network of processes (relations) that produced them, and constitute it (the machine) as a concrete unity in space in which they (the components) exist by specifying the topological domain of its realization as such a network. AI research shows that autopoietic machines may be used as a basis for constructing systems having key AGI characteristics, behaviours and qualities. However, creating autopoietic machines with true self-programming abilities, and with an ability to be scaled to produce complex and useful AGI systems, has so far not been accomplished.

In mathematics, a dynamical system is a system whose state evolves with time over a state space according to one or more rules. A complex dynamical system is a dynamical system that is composed of multiple different components which interact with each other at points of intersection. An attractor is a set of values or states toward which a dynamical system tends to evolve over time for a variety of starting conditions. AI research also shows that cognitive systems may be regarded as complex dynamical systems in which a mind capable of performing cognition is an autopoietic system of patterns and processes giving rise to a hierarchy of attractor structures.

The present invention has been developed against this background.

### SUMMARY

According to the present invention, there is provided a method for constructing a self-programming machine that emulates a complex dynamical system, the method comprising:

determining a target attractor of the complex dynamical system, wherein the target attractor comprises a plurality of event processing nodes and a plurality of event flows that propagate between the event processing nodes;

constructing a process model of the target attractor, wherein the process model is fragmented and comprises a plurality of event processing nodes corresponding to the event processing nodes of the target attractor;

constructing a self-programming machine comprising a plurality of logical processing units, wherein each of the logical processing units comprises:
a communications interface for communicating with one or more other of the logical processing units;
an input for receiving information from an environment or process that is external to the self-programming machine; and
an output for sending information to the environment or process;

constructing a plurality of instances of the process model with interaction regions logically interposed between the instances of the process model;

associating each of the instances of the process model with one of the logical processing units; and

configuring the logical processing units such that they:
form bindings between the event processing nodes in the instances of the process model via the interaction regions in accordance with the event flows in the target attractor;
generate, send and receive event signals via their respective communications interfaces in accordance with the bindings; and
process event signals received via their respective communications interfaces and information received via their respective inputs to thereby determine information that is sent via their respective outputs.

The method may further comprise configuring the logical processing units such that the bindings that are formed via the interaction regions connect together event processing nodes that are in different instances of the process model.

The method may further comprise configuring the logical processing units such that the bindings that are formed via the interaction regions connect together event processing nodes that are in a common instance of the process model.

The method may further comprise configuring the logical processing units such that the bindings that are formed via the interaction regions connect together event processing nodes in the instances of the process model on a one-to-many and/or many-to-one basis.

The method may further comprise configuring the logical processing units such that for each pair of consecutive event processing nodes in the instances of the process model that are connected on a one-to-many or many-to-one basis:

output event flow occurrences associated with a first of the nodes in the pair are aggregated to produce a total value; and

if the total value meets or exceeds a threshold value, then input event flow occurrences associated with a second of the nodes in the pair are triggered.

The method may further comprise configuring the logical processing units such that the bindings are formed, destroyed and changed on a continuous or perpetual basis.

The method may further comprise configuring the logical processing units such that when event signals are generated by one of the logical processing units and processed by one or more other of the logical processing units in accordance with the bindings, the relevant event signals are processed by the other of the logical processing units simultaneously, or substantially simultaneously.

The method may further comprise:

constructing a model of the target attractor that comprises a plurality of nodes connected together by edges, wherein each of the nodes corresponds to one of the event processing nodes of the target attractor and each of the edges corresponds to one of the event flows in the target attractor;

constructing a fragmented model of the target attractor by dissecting each of the edges of the model into at least two edge segments;

constructing a plurality of instances of the fragmented model and associating each of the instances of the fragmented model with one of the logical processing units; and

configuring the logical processing units such that the bindings are formed between the edge segments in the instances of the fragmented model.

The input of each of the logical processing units may be configured such that it is triggered by a feature detection mechanism relative to the environment or process that is external to the self-programming machine.

The output of each of the logical processing units may be configured such that it triggers an action feature mechanism relative to the environment or process that is external to the self-programming machine.

The target attractor that is determined by the method may comprise:

a pair of cycles comprising a forwards cycle and a backwards cycle that intersect at first and second intersection points, wherein the cycles are counteracting and correspond to event flows in the target attractor constituting a resonant circuit; and

a pair of event processing nodes corresponding to the intersection points.

The method may further comprise:

constructing a model of the target attractor that comprises first and second nodes corresponding to, respectively, the first and second intersection points, wherein the nodes are connected together by four edges corresponding to the cycles;

constructing a fragmented model of the target attractor by dissecting each of the four edges of the model into at least two edge segments, such that the fragmented model comprises four input edge segments and four output edge segments and the input and output edge segments are separated by four discontinuities;

constructing a plurality of instances of the fragmented model and associating each of the instances of the fragmented model with one of the logical processing units; and

forming the bindings between the edge segments in the instances of the fragmented model.

The method may further comprise:

assigning an input variable and an output variable to each of the logical processing units;

assigning variables to the input and output edge segments in the instances of the fragmented model and using the variables to track the event flows in the target attractor associated with the relevant edge segments that most recently occur;

for each individual discontinuity in the four discontinuities:
assigning at least one counter to the individual discontinuity and using a value of the counter to determine robustness of potential bindings or non-bindings associated with the individual discontinuity; and
assigning at least one status variable to the individual discontinuity and using the status variable to track event flows through bindings formed via the discontinuity; and

updating the relevant variables assigned to the input edge segments in the instances of the fragmented model based on values stored in the counter and status variable assigned to each individual discontinuity.

The method may further comprise setting the counter to either:

a first value that indicates that a binding is formed across the relevant individual discontinuity;

a second value that indicates that a binding is not formed across the relevant individual discontinuity; or

a third value that indicates that a binding may or may not be formed across the relevant individual discontinuity.

The method may further comprise configuring the counter such that it is a static variable having a fixed value that indicates that a binding may or may not be formed across the relevant individual discontinuity.

The method may further comprise:

accumulating all event flows through bindings formed via the four discontinuities based on the relevant values of the counters assigned to the four discontinuities; and

if the event flows meet or exceed a threshold value once accumulated, triggering and recording one or more event flows in the variables assigned to the input edge segments in the instances of the fragmented model.

A status of each of the counters may be:

promoted when event flows that are triggered satisfy a set of synchronization criteria; and

demoted when event flows that are triggered do not satisfy the set of synchronization criteria.

The method may further comprise:

assigning first and second event variables to, respectively, the first and second nodes in the instances of the fragmented model; and

using the event variables to track synchronicity of event flows associated with the first and second nodes and the output and input variables assigned to the logical processing units.

The method may further comprise:

applying a set of heuristics to each of the nodes in the instances of the fragmented model; and

using the heuristics to establish and maintain optimum synchrony as tracked via the first and second event variables.

The method may further comprise applying and using the heuristics such that they:

cover event flows associated with all edge segments in the instances of the fragmented model;

determine statuses of the input and output variables assigned to each of the logical processing units; and

determine modifications to the first and second event variables and the relevant variables assigned to the output edge segments in the instances of the fragmented model, to thereby determine event flows output from the nodes in the instances of the fragmented model.

The method may further comprise applying and using the heuristics such that:

when a set of synchrony criteria associated with the nodes is met or satisfied, the formation of bindings is promoted between each pair of nodes across the four discontinuities that will, or may, increase the likelihood of the set of synchrony criteria being subsequently met or satisfied; and

when the set of synchrony criteria associated with the nodes is not met or satisfied, the formation of bindings is demoted between each pair of nodes across the four discontinuities of the fragmented model that will, or may, reduce the likelihood of the synchrony criteria subsequently not being met or satisfied.

The present invention also provides a self-programming machine, comprising:

a plurality of logical processing units, wherein each of the logical processing units comprises:
a communications interface for communicating with one or more other of the logical processing units;
an input for receiving information from an environment or process that is external to the self-programming machine; and
an output for sending information to the environment or process;

a plurality of instances of a fragmented process model of a target attractor of a complex dynamical system, wherein each of the instances of the fragmented process model is associated with one of the logical processing units, and wherein the target attractor comprises a plurality of event processing nodes and a plurality of event flows that propagate between the event processing nodes, and wherein the fragmented process model comprises a plurality of event processing nodes corresponding to the event processing nodes of the target attractor; and

interaction regions logically interposed between the instances of the fragmented process model,

wherein the logical processing units are configured to:

form bindings between the event processing nodes in the instances of the fragmented process model via the interaction regions in accordance with the event flows in the target attractor;

generate, send and receive event signals via their respective communications interfaces in accordance with the bindings; and

process event signals received via their respective communications interfaces and information received via their respective inputs to thereby determine information that is sent via their respective outputs.

The present invention also provides a computer-readable non-transitory medium storing executable instructions which, when executed by a processor of a computer system, cause the computer system to:

generate a plurality of logical processing units, wherein each of the logical processing units comprises:
a communications interface for communicating with one or more other of the logical processing units;
an input for receiving information from an environment or process that is external to the self-programming machine; and
an output for sending information to the environment or process;

instantiate a plurality of instances of a fragmented process model of a target attractor of a complex dynamical system, wherein each of the instances of the fragmented process model is associated with one of the logical processing units, and wherein the target attractor comprises a plurality of event processing nodes and a plurality of event flows that propagate between the event processing nodes, and wherein the fragmented process model comprises a plurality of event processing nodes corresponding to the event processing nodes of the target attractor;

generate interaction regions logically interposed between the instances of the fragmented process model;

form bindings between the event processing nodes in the instances of the fragmented process model via the interaction regions in accordance with the event flows in the target attractor;

cause the logical processing units to generate, send and receive event signals via their respective communications interfaces in accordance with the bindings; and

cause the logical processing units to process event signals received via their respective communications interfaces and information received via their respective inputs to thereby determine information that is sent via their respective outputs.

### BRIEF DESCRIPTION OF DRAWINGS

Embodiments of the invention will now be described by way of example only with reference to the accompanying drawings, in which:

FIG. 1 is a flowchart of a method for constructing a self-programming machine that emulates a complex dynamical system according to an example embodiment of the invention;

FIG. 2 is a schematic diagram of a self-programming machine that may be constructed and configured using the method;

FIG. 3A is a schematic diagram of a process model of a target attractor of a complex dynamical system;

FIG. 3B is a schematic diagram of a fragmented version of the process model;

FIG. 4A is a schematic diagram of a plurality of instances of the fragmented version of the process model, wherein each of the instances is associated with a logical processing unit;

FIG. 4B is a schematic diagram of the plurality of instances shown with bindings formed between opposed edge segments of the instances via interaction regions;

FIG. 5 is a schematic diagram showing example bindings that may be formed between opposed event processing nodes in the plurality of instances;

FIG. 6 is a schematic diagram of a process model of a target attractor of a further complex dynamical system, wherein the target attractor comprises a pair of counteracting cycles that constitute a resonant circuit;

FIG. 7 is a schematic diagram of a fragmented version of the process model in FIG. 6; and

FIG. 8 is a pair of graphs illustrating how the internal state of the self-programming machine may change over time in response to information received from an external environment or process.

### DESCRIPTION OF EMBODIMENTS

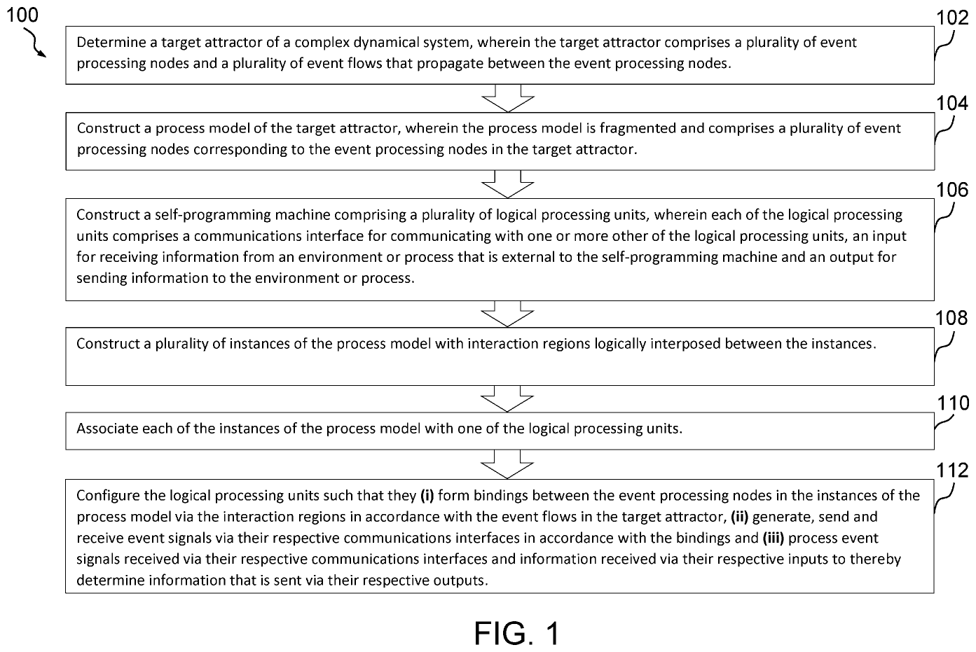

Referring to FIG. 1, an example embodiment of the present invention provides a method 100 for constructing a self-programming machine that emulates a complex dynamical system.

The method 100 comprises: (a) determining a target attractor of a complex dynamical system, wherein the target attractor comprises a plurality of event processing nodes and a plurality of event flows that propagate between the event processing nodes (block 102); (b) constructing a process model of the target attractor, wherein the process model is fragmented and comprises a plurality of event processing nodes corresponding to the event processing nodes in the target attractor (block 104); (c) constructing a self-programming machine that comprises a plurality of logical processing units, wherein each of the logical processing units comprises a communications interface for communicating with one or more other of the logical processing units, an input for receiving information from an environment or process that is external to the self-programming machine and an output for sending information to the environment or process (block 106); (d) constructing a plurality of instances of the process model with interaction regions logically interposed between the instances (block 108); (e) associating each of the instances of the process model with one of the logical processing units (block 110); and (f) configuring the logical processing units such that they (i) form bindings between the event processing nodes in the instances of the process model via the interaction regions in accordance with the event flows in the target attractor, (ii) generate, send and receive event signals via their respective communications interfaces in accordance with the bindings and (iii) process event signals received via their respective communications interfaces and information received via their respective inputs to thereby determine information that is sent via their respective outputs (block 112).

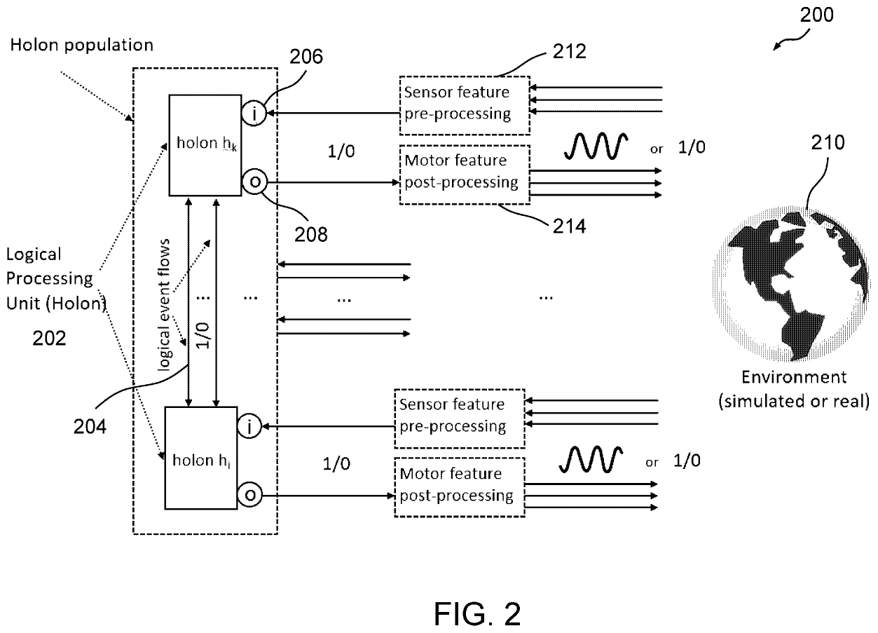

Referring to FIG. 2, there is provided a self-programming machine 200 that may be constructed and configured using the method 100. The self-programming machine 200 comprises a plurality of logical processing units (LPUs) 202. For the sake of simplicity, only two logical processing units 202 are depicted. However, it will be appreciated that the self-programming machine 200 may comprise a significantly higher number of the logical processing units 202.

Each logical processing unit 202 maintains its own internal state and executes in accordance with its state. However, each logical processing unit 202 also comprises an associated instance of the whole process model of the relevant target attractor emulated by the self-programming machine 200. The logical processing units 202, therefore, exhibit properties that are analogous to those of photographic holograms. In a hologram, each individual element of the hologram contains a particular perspective of an image and also the entire image. Consistent with this analogy, and for the sake of brevity, the logical processing units 202 of the self-programming machine 200 are hereinafter referred to as “holons” in this description.

The self-programming machine 200 also comprises communication interfaces which are configured such that each holon 202 can each send and receive event signals 204 to and from one or more other of the holons 202. The communication interfaces may be adapted such that they provide for the logical and/or physical propagation of event signals 204 in binary form. Each of the holons 202 also comprises an input 206 and an output 208. The inputs 206 allow the holons 202 to receive information that relates to an environment or process 210 that is external to the self-programming machine 200. The outputs 208 allow the holons 202 to send information to the external environment or process 210.

The inputs and outputs 206, 208 may provide that the holons 202 may be (respectively) responsive to, and capable of affecting, one or more dynamic elements of the external environment or process 210. For example, each input 206 may be configured such that it is triggered by a feature detection mechanism relative to the environment or process 210. Similarly, each output 208 may trigger an action feature mechanism relative to the environment or process 210. Each input 206 and output 208 may be binary in nature. Information relating to the environment or process 210 may be subjected to sensor feature pre-processing 212 prior to triggering the input 206. Similarly, information from the output 208 may be subjected to motor feature post-processing 214 prior to triggering the relevant action feature mechanism.

The method 100 is used to configure the machine 200 such that the machine 200 operates on a self-programming basis and emulates a complex dynamical system. For the first step in the method 100, a target attractor of a complex dynamical system is determined. The target attractor preferably comprises a plurality of event processing nodes that occur in the complex dynamical system. The target attractor also preferably comprises a plurality of logical event flows that propagate between the event processing nodes in the target attractor. A process model of the target attractor is then constructed. The process model may comprise a plurality of event processing nodes corresponding to the event processing nodes of the target attractor.

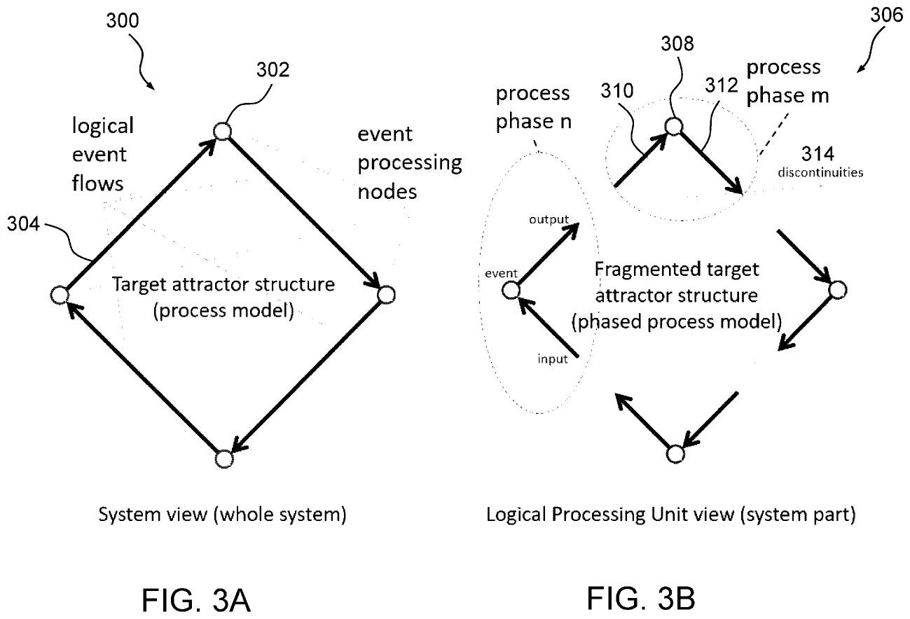

An example process model 300 that may be constructed is shown in FIG. 3A. The process model 300 comprises four event processing nodes 302 arranged in a diamond formation that are connected together by four edges 304. Each of the edges 304 is directional and corresponds to one of the event flows in the target attractor. Each edge 304, therefore, designates a directed logical path along which event occurrences in the complex dynamical system (i.e., logical event flows) may propagate. The nodes 302 and edges 304, together, form a directed graph that provides a functional model of the target attractor.

As illustrated in FIG. 3B, each of the edges 304 of the process model 300 may then be split or dissected into two separate directional edge segments to form a fragmented (or phased) process model 306 of the target attractor. The fragmented model 306, therefore, comprises four event processing nodes 308, each of the nodes 308 comprising an input edge segment 310 and an output edge segment 312. Opposed pairs of the edge segments are separated by discontinuities 314. Each event processing node 308, and its respective input and output edge segment 310, 312, constitutes an individual process phase of the fragmented model 306. That is to say, each node 308 (or process phase) designates an event input>event processing>event output process sequence. Two of the process phases shown in FIG. 3B are labelled ‘n’ and ‘m’.

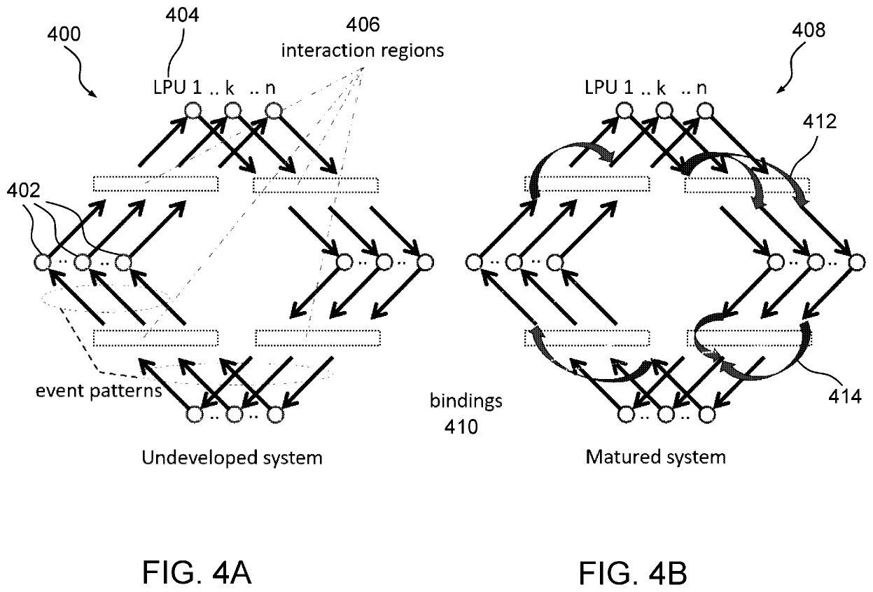

For the next step in the method 100, a plurality of instances of the fragmented process model 306 may then be instantiated. Each of the instances may then be associated with one of the holons 202. FIG. 4A depicts a system 400 comprising three example instances 402 of the fragmented process model 306 that have been instantiated and associated with, respectively, three holons 404. However, it will be appreciated that, more generally, N instances of the fragmented process model 306 may be instantiated and associated with N holons, wherein N is in the range of one to potentially millions. The quantity of N that is selected is based on a particular task or problem that the self-programming machine 200 may be configured to perform or solve. For example, if the self-programming machine 200 is configured to perform a pattern recognition or signal analysis task which involves a set of 1,000 input data items or streams received in parallel, the value of N may be 1,000. Each holon 202 maintains and utilises its own private instance 402 of the fragmented process model 306 as its internal processing model.

The instances 402 are logically aligned relative to one another such that interaction regions 406 are logically interposed between the instances 402. The interaction regions 406 provide a medium through which bindings may be formed or determined between opposed pairs of edge segments of the instances 402. The event processing nodes 308 in the instances (and, therefore, process phases) are, therefore, also logically aligned. The bindings serve to connect together the event processing nodes 308 of the instances 402 via the interaction regions 406 and allow for cross-talk between the holons 404. The logically aligned process phases and event flows constitute a scheme of dynamic input/output event patterns on a system level.

In FIG. 4A, the system 400 is shown in an undeveloped state where no bindings have been formed between edge segments of the instances 402. Referring to FIG. 4B, a developed version of the system 408 is shown wherein bindings 410 have been formed between various edge segments of the instances 402 via the interaction regions 406. The bindings 410 are formed or determined such that they accord with event flows occurring in the target attractor of the complex dynamical system. That is to say, the bindings are only established when the direction of event flows designated in the target attractor are satisfied. Preferably, the self-programming machine 200 is configured such that the bindings 410 are formed, destroyed and/or altered automatically on an ongoing or perpetual basis. The bindings 410 are, therefore, continually evolving to reflect the event flows in the target attractor. In an undeveloped state, no (or only random) bindings exist. When in a developed state, the bindings provide that the edge segments of the instances 402 are stitched together and the holons 404 of the self-programming machine 200 are in a quasi-stable matured state.

The bindings 410 that are formed may connect together event processing nodes 308 that are in the same and/or different instances 402 of the fragmented process model 306, including on a one-to-many and many-to-one basis. For example, in FIG. 4B the matured system 408 comprises a set of bindings 412 that connect together a set of nodes in the instances 402 on a one-to-many basis. Another set of bindings 414 are shown that connect together a set of nodes on a many-to-one basis.

For each pair of consecutive event processing nodes 308 in the instances 402 that are connected together on a one-to-many or many-to-one basis, the holons 404 may be configured such that they aggregate output event flow occurrences associated with the first of the nodes in the pair and combine these occurrences to calculate a total value. For example, if an individual instance of the event processing node (process phase) labelled ‘n’ in FIG. 3B is connected via the bindings 410 to multiple instances of the node (process phase) labelled ‘m’ (i.e., a one-to-many relationship) then event flows associated with node ‘n’ that occur will be aggregated by the self-programming machine 200. If the total value that is calculated meets or exceeds a predetermined threshold, then input event flow occurrences associated with the second of the nodes in the pair are triggered by the holons 404. For example, in FIG. 3B event flow occurrences associated with the node ‘m’ will be triggered.

The holons 404 may be configured such that event signals 204 that are generated, sent and received via their respective communications interfaces are clustered into distinct logical event flows that are processed in a time synchronous manner. That is to say, when event signals 204 generated by one of the holons 404 are processed by one or more other of the holons 404 in accordance with the bindings, the relevant event signals are processed by the other holons 404 simultaneously, or substantially simultaneously.

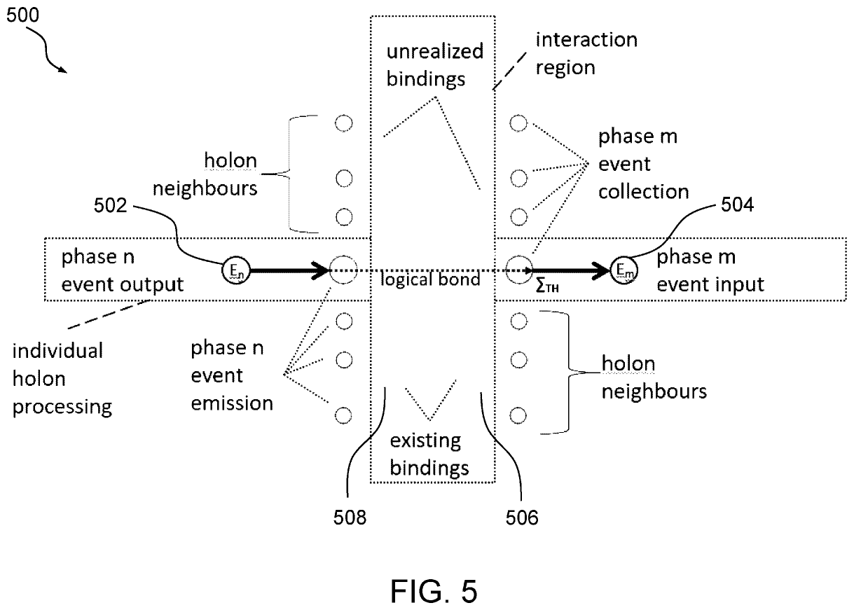

The schematic diagram 500 in FIG. 5 provides a further illustration of example bindings that may be formed or determined between event processing nodes (process phases) in different instances of the fragmented process model 306 via the interaction regions 406. The diagram 500 shows a pair of instances of the event processing nodes (process phases) ‘n’ and ‘m’ of FIG. 3B, which are labelled 502 and 504. The diagram 500 shows an example set of bindings formed on a one-to-many basis 506 and a set of bindings formed on a many-to-one basis 508. Realised bindings are shown with unbroken lines and unrealised bindings are shown with broken lines.

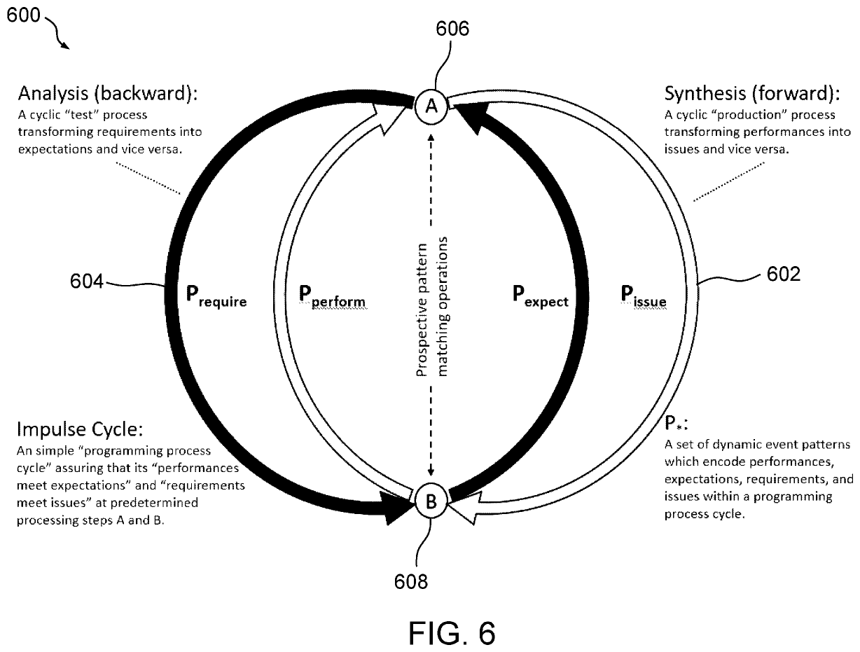

The self-programming machine 200 may be configured to emulate target attractors of complex dynamical systems that, in turn, may be used as building blocks for constructing more complex autopoietic systems. For example, referring to FIG. 6 there is provided a process model 600 of a target attractor of a further example complex dynamical system. The target attractor modelled by the process model 600 comprises a forward-flowing (clockwise) event cycle 602 and a backwards-flowing (anti-clockwise) event cycle 604 that, together, constitute a resonant circuit. The two cycles 602, 604 intersect at first and second intersection points which are modelled by a pair of event processing nodes 606, 608. The cycles 602, 604 are counteracting and are modelled by four directional edges that connect the nodes 606, 608 together. The target attractor, as modelled by the process model 600, is hereinafter referred to as an “impulse cycle”.

The impulse cycle 600 is inspired from observations in software engineering wherein software production activities comprise two interrelated sub-cycles: a forwards-flowing production cycle (synthesis) and a backwards-flowing test cycle (analysis). The two sub-cycles intersect (and interact) at two points to ensure that qualities are satisfied in the software production process. The synthesis cycle represents a cyclic “production” process which transforms performances into issues, and vice versa. The analysis cycle represents a cyclic “test” process which transforms requirements into expectations, and vice versa. The software programming process is only effective if it progressively ensures that its “performances meet expectations” and “requirements meet issues” at the two points of intersection.

Further relevant background to the operation and utility of the impulse cycle model is provided in Bartelt W., Ranjeet T., Saha A. (2019) Meta-Engineering: A Methodology to Achieve Autopoiesis in Intelligent Systems, the contents of which is incorporated herein by reference. In this paper, an autopoietic intelligent system (AIS) is disclosed that comprises automated “software production”-like processes based on meta-engineering (ME) theory. This paper explains that ME-theory is neither based on hypothesis nor merely a theoretical approach, but its foundations can be observed in the real-world activities of sophisticated engineering organizations. The paper discusses the existence of meta-engineering systems (MES) in various categories of software production systems. The paper further illustrates that MES possess an inherent ability to become general problem solvers by means of maximal specialization. MES learn from their experiences and utilize outcomes of such experiences to reconstruct themselves as systems that have improved learning capabilities. Such meta-learning capabilities lead to an exponential learning rate. The paper also attributes exponentially accelerating technological progress, as observed in engineering domains, to MES performances and explains that self-constructing MES reflect biologically inspired autopoiesis based on engineering principles applied in information technology.

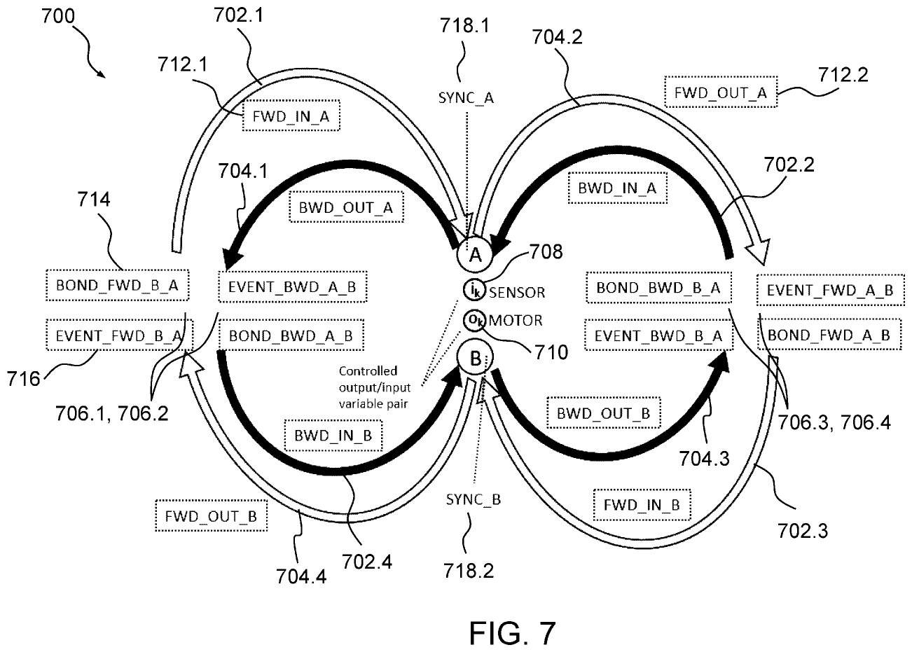

Referring to FIG. 7, once the impulse cycle 600 has been constructed each of its directional edges may then be split or dissected into at least two edge segments to form a fragmented model 700 of the target attractor. The fragmented model 700, therefore, comprises four input edge segments 702 that represent event flows into the event processing nodes 606, 608. The fragmented model 700 also comprises four output edge segments 704 that represent event flows away from the event processing nodes 606, 608. The complete set of edge segments 702, 704 are separated by four discontinuities 706.

A plurality of instances of the fragmented model 700 may then be created and associated with the holons 202 of the self-programming machine 200 on a one-to-one basis. The holons 202 may be configured to form bindings between the edge segments 702, 704 in the instances in accordance with the event flows in the target attractor.

A variety of different algorithms and methods may be employed to form bindings that reflect the attractor event flows. The following paragraphs describe an example method, which is the best method known to the applicant. Firstly, an input variable 708 and an output variable 710 may be assigned to each of the holons 202 in the holon population. The two variables 708, 710 correspond to the respective inputs 206 and outputs 208 of the holons 202 and provide the grounding for all of their programming actions. The variables 708, 710 may be assigned label names that reflect the relevant functions performed by the holon inputs 206 and outputs 208. For example, in FIG. 7 each input variable 708 is labelled “SENSOR” to reflect that it is triggered by a feature detection mechanism and each output variable 710 is labelled “MOTOR” to reflect that it triggers an action feature mechanism. Each holon 202 operates as a proxy on behalf of its assigned pair of variables 708, 710 and has exclusive ownership and control of its variables 708, 710.

Variables 712 may also be assigned to each of the input edge segments 702 and output edge segments 704 in the instances of the fragmented model 700. These variables 712 are used to record and track event occurrences associated with the edge segments 702, 704 that have most recently occurred during execution of the self-programming machine 200. Labels may be given to the variables 712 having names that reflect the type of events flows recorded by the relevant variables 712. For example, as shown in FIG. 7 each of the input edge segments 702 may be assigned a variable 712.1 with a label in the form XXX_IN_Y and each of the output edge segments 704 may be assigned a variable 712.2 with a label in the form XXX_OUT_Y. In each label, the string literal used for the field XXX may be either “FWD” or “BWD” depending on whether the relevant edge segment 702, 704 is forward (clockwise) or backwards (anti-clockwise) flowing. The character used for the field Y may be either ‘A’ or ‘B’ depending on the relevant event processing node 606, 608 that the relevant edge segment 702, 704 is connected to. For example, using this naming convention, a value stored in the variable 712 labelled “FWD_IN_A” may record that a forward input event has occurred for processing by the first event processing node 606 in an instance of the impulse cycle 600. A value stored in the variable 712 labelled “BWD_OUT_B” may record that a backward output event has occurred as a result of processing by the second event processing node 608 in an instance of the impulse cycle 600.

At least one counter 714 may also be assigned to each of the discontinuities 706 and labels may be given to the counters 714. For example, as shown in FIG. 7 each of the discontinuities 706 may be assigned a counter 714 having a label in the form BOND_XXX_Y_Z. In each label, the string literal used for the field XXX may be either “FWD” or “BWD” depending on whether the pair of edge segments 702, 704 that the relevant discontinuity 706 is interposed between are forwards (clockwise) or backwards (anti-clockwise) flowing. The characters used for the fields Y and Z may be either ‘A’ or ‘B’ depending on the relevant event processing nodes 606, 608 that such edge segments 702, 704 are connected to. Each counter 714 assigned to a discontinuity 706 is used to record and keep track of the status of logical bindings associated with the relevant discontinuity 706 that are formed.

Each counter 714 may be implemented using a tri-state variable that may be set to either (i) a first value that indicates that a binding is currently formed across the relevant discontinuity 706, (ii) a second value that indicates that a binding is currently not formed across the relevant discontinuity 706, (iii) or a third value that indicates that a binding may or may not be currently formed across the relevant discontinuity 706 (i.e., whether bindings are, or are not, formed across the relevant discontinuity 706 is irrelevant and, therefore, not taken into account by the algorithm). In other examples, one or more of the counters 714 may be a static variable that is assigned a fixed (unchangeable) value that indicates that bindings (or no bindings as the case may be) are formed across the relevant discontinuity 706 and this status is unchangeable.

At least one status variable 716 may also be assigned to each of the discontinuities 706 with labels given to the status variables 716. For example, as shown in FIG. 7 each of the discontinuities 706 may be assigned a status variable 716 with a label in the form EVENT_XXX_Y_Z using the same naming convention as for the labels given to the counters 714.

Once assigned, the respective values of the variables 712, counters 714 and status variables 716 can be referred to and used by the self-programming machine 200 to form, destroy and/or modify bindings on a continual basis in accordance with the event flows in the target attractor and information received via their respective inputs 206. For example, the variables 712.1, 712.2 assigned to both the input and output edge segments 702, 704 may be used to track event flows in the target attractor associated with the relevant edge segments 702, 704 that have most recently occurred. The values of the counters 714 may be used to determine robustness of potential bindings or non-bindings associated with the relevant discontinuities 706. The values of the status variables 716 may be used to track event flows propagating through bindings formed via the relevant discontinuities 706. The variables 712.1 assigned to just the input edge segments 702 in the instances of the fragmented model 700 may be updated by the self-programming machine 200 based on values stored in the counter 714 and status variable 716 assigned to each individual discontinuity 706

The self-programming machine 200 may also be configured such that all event flows propagating through bindings formed via the four discontinuities 706 are accumulated based on the relevant values of the counters 714 assigned to the discontinuities 706. If the accumulated event flows meet or exceed a threshold value, the self-programming machine 200 may cause an event flow to be triggered and recorded in the variables 712 assigned to the input edge segments 702 in the instances of the fragmented model 700. The self-programming machine 200 may also be configured such that the status of each of the non-static counters 714 is (i) promoted when event flows that are triggered satisfy a set of predetermined synchronization criteria and (ii) demoted when triggered event flows do not satisfy the set of synchronization criteria. The synchronization criteria may define preferred causal relationships between event flows propagating through the bindings. For example, the criteria may provide that event signals received from particular holons 202 should preferably precede particular event occurrences, or particular types of event occurrences.

To further facilitate synchronicity, first and second event variables 718.1, 718.2 may also be assigned to, respectively, the first and second nodes 606, 608 in each of the instances of the fragmented model 700 with labels given to the event variables 718.1, 718.2. For example, as shown in FIG. 7 the event variables 718.1, 718.2 may be labelled “SYNC_A” and “SYNC_B”. The self-programming machine 200 may be configured such that the event variables 718.1, 718.2 are used to track synchronicity of event flows associated with the first and second nodes 606, 608 and event flow information associated with the input and output variables 708, 710 assigned to the holons 202.

The self-programming machine 200 may also be configured to apply a set of heuristics to each of the nodes 606, 608 in each of the instances of the fragmented model 700. These heuristics may be used to establish and maintain optimum synchrony as tracked via the first and second event variables 718.1, 718.2. In such examples, the self-programming machine 200 may use the heuristics to cover event flows associated with all edge segments 702, 704 in the instances of the fragmented model 700.

The heuristics may also be used to determine the statuses of the input and output variables 708, 710 assigned to each of the holons 202. The heuristics may also be used to determine modifications to be made to the first and second event variables 718.1, 718.2 and to the variables 712.2 assigned to the output edge segments 704 in the instances of the fragmented model 700. This, in turn, enables the self-programming machine 200 to determine the event flows output from the nodes 606, 608 in the instances of the fragmented model 700 with more accuracy.

Synchronization criteria, as referred to above, may be associated with the nodes 606, 608 in the instances of the fragmented model 700. In such examples, the heuristics may also be used such that when the criteria are met or satisfied, the self-programming machine 200 promotes the formation of bindings between each pair of nodes 606, 608 across the four discontinuities 706 that will (or may) increase the likelihood of the criteria being subsequently met or satisfied. Similarly, when the criteria are not satisfied, the self-programming machine 200 may then operate to demote the formation of bindings between each pair of nodes 606, 608 across the four discontinuities 706 that will (or may) reduce the likelihood of the criteria subsequently not being met or satisfied.

When implemented using the self-programming machine 200, the impulse cycle process model 600 illustrated in FIG. 6 provides a simple systemic cybernetic knowledge acquisition process that operates in a perpetual closed loop dynamic. The impulse cycle 600 provides a building block which can, in turn, be used to construct and execute more complex process models and attractors, including multi-levelled, stacked and nested attractors for complex dynamical systems.

The methods and procedures described herein may all be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware and/or may be implemented using hardware components such as microprocessors, programmable logic arrays, application-specific integrated circuits, programmable logic devices, field-programmable gate arrays and similar combinatorial logic devices. The instructions may be configured to be executed by one or more processors (including virtual processors) which, when executing the series of computer instructions, perform or facilitate the performance of all or part of the disclosed methods and procedures.

For example, holons 202 of the self-programming machine 200 may be implemented and executed on a single computer system or may be distributed across a network of multiple computer systems. The computer system or network that implements the holons 202 may comprise one or more memory devices that are used to store holon-specific data and state. This includes data relating to, and embodying, event flows propagating through holon bindings. As used herein, a memory device refers to a volatile or non-volatile memory device, such as RAM, ROM, EEPROM or any other device capable of storing data. In examples that comprise single-processor (or single-threaded) computer implementations, the self-programming machine 200 may be configured such that the holons 202 execute their internal processing models sequentially (for example, on a time-sliced basis). In multiprocessor architecture implementations, the holons 202 may execute their internal processing models in parallel.

When configured using the method 100, the self-programming machine 200 provides a cybernetic system that has scalable complexity and embodies and exhibits autopoietic principles and characteristics. The invention provides a means to enable self-creating systems or processes that have a genuine self-(re)programming capability with widespread industrial and practical applications. This includes for pattern recognition, machine learning, anomaly detection, self-optimization, cognitive systems and autonomous robotics. Further, the invention provides a solution for the realization of complex dynamical systems with predetermined attractor structures for the purpose of achieving a desirable outcome from their process performance.

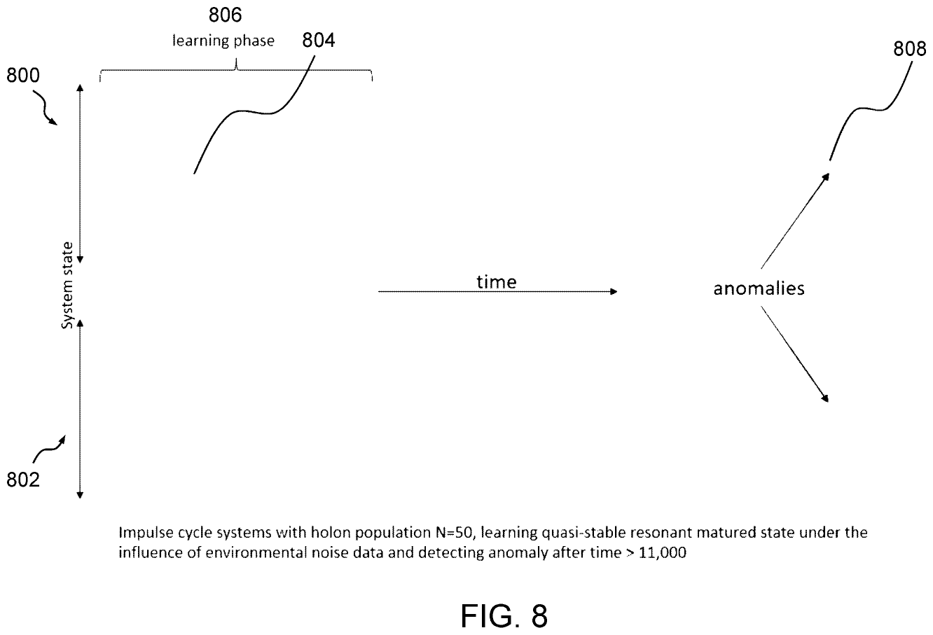

For example, FIG. 8 provides a pair of graphs 800, 802 that were generated using experiments involving the self-programming machine 200 to perform pattern or signal recognition. In each experiment, the self-programming machine 200 comprised a population of fifty holons 202 and was configured using the method 100 to implement the impulse cycle process model 600. Signal information having a cyclic (recurring) pattern was supplied to the holons 202 via their inputs 206. The two graphs 800, 802 illustrate how the internal state of the self-programming machine 200 changes and reacts over time in response to such information.

Each vertical axis of the graphs 800, 802 represents a quantified value of the collective internal state of the holons 202 during the experiments, generated using a Fourier transform of data embodying their internal state. Each horizontal axis represents elapsed time or process cycles of the self-programming machine 200.

Referring to the first graph 800, at the start of the first experiment the holons 202 were initially in a stable non-resonant state and exposed to a random input signal. The test input signal was first supplied to the holons 202 at the point in time labelled 804. This caused the holons 202 to react and undergo an initial learning phase 806. During this learning phase 806, the self-programming machine 200 formed bindings between the holons 202 in an effort to obtain stability and resonance in response to the signal. At the end of the learning phase 806, the holons 202 were quasi-stable and their collective state was resonant, or at least substantially resonant, with the test input signal. The self-programming machine 200 had, therefore, re-programmed itself such that its internal state reflected (or rather recognised) the signal being continuously fed to the holons 202.

At the point in time labelled 808, the information being supplied to the holons 202 was modified such that anomalous data inconsistent with the previous test signal was added. As shown in the graph 800, this caused the state of the holons 202 to be thrown back into an unstable state. The self-programming machine 200 had, therefore, recognised the anomalous data and recommenced re-programming of its bindings to form/learn a new internal holon state that would reflect the new signal.

The second graph 802 shows the results of a similar experiment carried out using different test input signal information supplied to the self-programming machine 200. The graph 802 shows that the machine 200 was also able to re-programme its bindings and achieve resonance with the input signal when the signal was changed at the same two points in time.

For the purpose of this specification, the word “comprising” means “including but not limited to”, and the word “comprises” has a corresponding meaning. Further, the words “preferably”, including variations such as “preferred”, and “may” will be understood to imply that a stated integer or group of integers is desirable but not essential to the working of the invention. It is also to be understood that, if any prior art is referred to in this specification, such reference does not constitute an admission that the prior art forms a part of the common general knowledge in the art in any country.

The above embodiments have been described by way of example only and modifications are possible within the scope of the claims that follow.

1. A method for constructing a self-programming machine, the method comprising:
determining a target attractor of a complex dynamical system performing a self-programming function, wherein the target attractor comprises a plurality of event processing nodes and a plurality of event flows that propagate between the event processing nodes;
constructing a process model of the target attractor, wherein the process model is fragmented and comprises a plurality of event processing nodes corresponding to the event processing nodes of the target attractor;
constructing a self-programming machine comprising a plurality of logical processing units, wherein each of the logical processing units comprises:
a communications interface for communicating with one or more other of the logical processing units;
an input for receiving information from an environment or process that is external to the self-programming machine; and
an output for sending information to the environment or process;
constructing a plurality of instances of the process model with interaction regions logically interposed between the instances of the process model;
associating each of the instances of the process model with one of the logical processing units; and
configuring the logical processing units to:
form bindings between the event processing nodes in the instances of the process model via the interaction regions in accordance with the event flows in the target attractor;
generate, send and receive event signals via their respective communications interfaces in accordance with the bindings; and
process event signals received via their respective communications interfaces and information received via their respective inputs to thereby determine information that is sent via their respective outputs,
such that the self-programming machine is caused to emulate the self-programming function.

2. The method according to claim 1, wherein the method further comprises configuring the logical processing units such that the bindings that are formed via the interaction regions connect together event processing nodes that are in different instances of the process model.

3. The method according to claim 1, wherein the method further comprises configuring the logical processing units such that the bindings that are formed via the interaction regions connect together event processing nodes that are in a common instance of the process model.

4. The method according to claim 1, wherein the method further comprises configuring the logical processing units such that the bindings that are formed via the interaction regions connect together event processing nodes in the instances of the process model on a one-to-many and/or many-to-one basis.

5. The method according to claim 4, wherein the method further comprises configuring the logical processing units such that for each pair of consecutive event processing nodes in the instances of the process model that are connected on a one-to-many or many-to-one basis:
output event flow occurrences associated with a first of the nodes in the pair are aggregated to produce a total value; and
if the total value meets or exceeds a threshold value, then input event flow occurrences associated with a second of the nodes in the pair are triggered.

6. The method according to claim 1, wherein the method further comprises configuring the logical processing units such that the bindings are formed, destroyed and changed on a continuous or perpetual basis.

7. The method according to claim 1, wherein the method further comprises configuring the logical processing units such that when event signals are generated by one of the logical processing units and processed by one or more other of the logical processing units in accordance with the bindings, the relevant event signals are processed by the other of the logical processing units simultaneously, or substantially simultaneously.

8. The method according to claim 1, wherein the method further comprises:
constructing a model of the target attractor that comprises a plurality of nodes connected together by edges, wherein each of the nodes corresponds to one of the event processing nodes of the target attractor and each of the edges corresponds to one of the event flows in the target attractor;
constructing a fragmented model of the target attractor by dissecting each of the edges of the model into at least two edge segments;
constructing a plurality of instances of the fragmented model and associating each of the instances of the fragmented model with one of the logical processing units; and
configuring the logical processing units such that the bindings are formed between the edge segments in the instances of the fragmented model.

9. The method according to claim 8, wherein the input of each of the logical processing units is configured such that it is triggered by a feature detection mechanism relative to the environment or process that is external to the self-programming machine.

10. The method according to claim 8, wherein the output of each of the logical processing units is configured such that it triggers an action feature mechanism relative to the environment or process that is external to the self-programming machine.

11. The method according to claim 8, wherein the target attractor that is determined by the method comprises:
a pair of cycles comprising a forwards cycle and a backwards cycle that intersect at first and second intersection points, wherein the cycles are counteracting and correspond to event flows in the target attractor constituting a resonant circuit; and
a pair of event processing nodes corresponding to the intersection points.

12. The method according to claim 11, wherein the method further comprises:
constructing a model of the target attractor that comprises first and second nodes corresponding to, respectively, the first and second intersection points, wherein the nodes are connected together by four edges corresponding to the cycles;
constructing a fragmented model of the target attractor by dissecting each of the four edges of the model into at least two edge segments, such that the fragmented model comprises four input edge segments and four output edge segments and the input and output edge segments are separated by four discontinuities;
constructing a plurality of instances of the fragmented model and associating each of the instances of the fragmented model with one of the logical processing units; and
forming the bindings between the edge segments in the instances of the fragmented model.

13. The method according to claim 12, wherein the method further comprises:
assigning an input variable and an output variable to each of the logical processing units;
assigning variables to the input and output edge segments in the instances of the fragmented model and using the variables to track the event flows in the target attractor associated with the relevant edge segments that most recently occur;
for each individual discontinuity in the four discontinuities:
assigning at least one counter to the individual discontinuity and using a value of the counter to determine robustness of potential bindings or non-bindings associated with the discontinuity; and
assigning at least one status variable to the individual discontinuity and using the status variable to track event flows through bindings formed via the discontinuity; and
updating the relevant variables assigned to the input edge segments in the instances of the fragmented model based on values stored in the counter and status variable assigned to each individual discontinuity.

14. The method according to claim 13, wherein the method further comprises setting the counter to either:
a first value that indicates that a binding is formed across the relevant individual discontinuity;
a second value that indicates that a binding is not formed across the relevant individual discontinuity; or
a third value that indicates that a binding may or may not be formed across the relevant individual discontinuity.

15. The method according to claim 13, wherein the method further comprises configuring the counter such that it is a static variable having a fixed value that indicates that a binding may or may not be formed across the relevant individual discontinuity.

16. The method according to claim 13, wherein the method further comprises:
accumulating all event flows through bindings formed via the four discontinuities based on the relevant values of the counters assigned to the four discontinuities; and
if the event flows meet or exceed a threshold value once accumulated, triggering and recording one or more event flows in the variables assigned to the input edge segments in the instances of the fragmented model.

17. The method according to claim 16, wherein a status of each of the counters is:
promoted when event flows that are triggered satisfy a set of synchronization criteria; and
demoted when event flows that are triggered do not satisfy the set of synchronization criteria.

18. The method according to claim 17, wherein the method further comprises:
assigning first and second event variables to, respectively, the first and second nodes in the instances of the fragmented model; and
using the event variables to track synchronicity of event flows associated with the first and second nodes and the output and input variables assigned to the logical processing units.

19. The method according to claim 18, wherein the method further comprises:
applying a set of heuristics to each of the nodes in the instances of the fragmented model; and
using the heuristics to establish and maintain optimum synchrony as tracked via the first and second event variables.

20. The method according to claim 19, wherein the method further comprises applying and using the heuristics such that they:
cover event flows associated with all edge segments in the instances of the fragmented model;
determine statuses of the input and output variables assigned to each of the logical processing units; and
determine modifications to the first and second event variables and the relevant variables assigned to the output edge segments in the instances of the fragmented model, to thereby determine event flows output from the nodes in the instances of the fragmented model.

21. The method according to claim 20, wherein the method further comprises applying and using the heuristics such that:
when a set of synchrony criteria associated with the nodes is met or satisfied, the formation of bindings is promoted between each pair of nodes across the four discontinuities that will, or may, increase the likelihood of the set of synchrony criteria being subsequently met or satisfied; and
when the set of synchrony criteria associated with the nodes is not met or satisfied, the formation of bindings is demoted between each pair of nodes across the four discontinuities of the fragmented model that will, or may, reduce the likelihood of the synchrony criteria subsequently not being met or satisfied.

22. A self-programming machine, comprising:
a plurality of logical processing units, wherein each of the logical processing units comprises:
a communications interface for communicating with one or more other of the logical processing units;
an input for receiving information from an environment or process that is external to the self-programming machine; and
an output for sending information to the environment or process;
a plurality of instances of a fragmented process model of a target attractor of a complex dynamical system, wherein the target attractor and complex dynamical system perform a self-programming function, wherein each of the instances of the fragmented process model is associated with one of the logical processing units, and wherein the target attractor comprises a plurality of event processing nodes and a plurality of event flows that propagate between the event processing nodes, and wherein the fragmented process model comprises a plurality of event processing nodes corresponding to the event processing nodes of the target attractor; and
interaction regions logically interposed between the instances of the fragmented process model,
wherein the logical processing units are configured to:
form bindings between the event processing nodes in the instances of the fragmented process model via the interaction regions in accordance with the event flows in the target attractor;
generate, send and receive event signals via their respective communications interfaces in accordance with the bindings; and
process event signals received via their respective communications interfaces and information received via their respective inputs to thereby determine information that is sent via their respective outputs,
such that the self-programming machine is caused to emulate the self-programming function.

23. A computer-readable non-transitory medium storing executable instructions which, when executed by a processor of a computer system, cause the computer system to:
generate a plurality of logical processing units, wherein each of the logical processing units comprises:
a communications interface for communicating with one or more other of the logical processing units;
an input for receiving information from an environment or process that is external to the self-programming machine; and
an output for sending information to the environment or process;
instantiate a plurality of instances of a fragmented process model of a target attractor of a complex dynamical system, wherein the target attractor and complex dynamical system perform a self-programming function, wherein each of the instances of the fragmented process model is associated with one of the logical processing units, and wherein the target attractor comprises a plurality of event processing nodes and a plurality of event flows that propagate between the event processing nodes, and wherein the fragmented process model comprises a plurality of event processing nodes corresponding to the event processing nodes of the target attractor;
generate interaction regions logically interposed between the instances of the fragmented process model;
form bindings between the event processing nodes in the instances of the fragmented process model via the interaction regions in accordance with the event flows in the target attractor;
cause the logical processing units to generate, send and receive event signals via their respective communications interfaces in accordance with the bindings; and
cause the logical processing units to process event signals received via their respective communications interfaces and information received via their respective inputs to thereby determine information that is sent via their respective outputs, such that the self-programming machine is caused to emulate the self-programming function.
